(19) United States
(12) Patent Application Publication
(10) Pub. No.: US 2026/0099568 A1
(43) Pub. Date: Apr. 9, 2026

(54) SECURE REAL-NUMBER MULTIPLICATION METHOD AND APPARATUS BASED ON SCALE TRANSFORMATION

(71) Applicant: Beihang University, Beijing (CN)

(72) Inventors: Tianle TAO, Beijing (CN); Shizhao PENG, Beijing (CN); Haogang ZHU, Beijing (CN)

(21) Appl. No.: 18/980,893

(22) Filed: Dec. 13, 2024

(30) Foreign Application Priority Data
Oct. 8, 2024 (CN) 202411397347.4

(51) Int. Cl. G06F 17/16; G06F 7/52

(52) U.S. Cl. CPC G06F 17/16; G06F 7/52

(57) ABSTRACT

Provided is a secure real-number multiplication method and apparatus based on scale transformation, which relates to the technical field of secure real-number multiplication. The secure real-number multiplication method includes: determining, by each participant, a private input value; performing, by each participant, scale transformation on the private input value to generate a private input matrix; with the private input matrix as input, computing, by each participant, a private output matrix by utilizing a Secure Two-Party Matrix Multiplication (S2PM) protocol based on a secure data disguising technology; calculating, by each participant, a sum of all elements in the private output matrix to obtain a private output value; and sending, by each participant, the private output value to a computation requester to obtain a secure real-number multiplication result.

### CROSS REFERENCE TO RELATED APPLICATION

This patent application claims the benefit and priority of Chinese Patent Application No. 2024113973474, filed with the China National Intellectual Property Administration on Oct. 8, 2024, the disclosure of which is incorporated by reference herein in its entirety as part of the present application.

### TECHNICAL FIELD

The present disclosure relates to the technical field of secure real-number multiplication, and in particular, to a secure real-number multiplication method and apparatus based on scale transformation.

### BACKGROUND

In recent years, the technology of large artificial intelligence models has developed rapidly, leveraging the power of data to drive advancements across various fields. As the importance of data increases, the emphasis on data privacy protection also increases. With the enormous volume of data being produced globally, the significance of protecting data privacy has grown, while the challenges of effectively safeguarding private data and preventing data breaches have also intensified. Due to privacy concerns and relevant data regulations, breaking down data silos while ensuring data privacy and security of all parties is a significant research issue. It is a significant research issue nowadays to integrate and circulate multi-source data in distributed heterogeneous scenarios by utilizing the technology of general large artificial intelligence models, to fully unlock the immense value contained in the vast amounts of data in the context of the WEB 3.0 era. During the process of privatizing large artificial intelligence models, many computational processes in scenarios such as logistic regression privatization and multi-layer perceptron privatization often require secure real-number multiplication. Additionally, secure real-number multiplication can also be applied to achieve secure vector bit multiplication and secure matrix bit multiplication operations, thus having broader application scenarios.

Currently, commonly used secure real-number multiplication schemes both domestically and internationally mainly include the following three types:

(1) The Obliv-C framework proposed by Zahur and Evans, and the ABY framework proposed by Demmler, Schneider, and others, both utilize the garbled circuit technology. The garbled circuit technology transforms mathematical operations (addition and multiplication) into Boolean circuits and protects circuit outputs corresponding to respective inputs by using encryption techniques such as secure shuffling and oblivious transfer.

(2) The MP-SPDZ framework proposed by Keller and the Crypten framework proposed by Knott, Venkataraman, and others both employ the secret sharing technology to hide secret values. Each secret value is randomly split into multiple shares; the participating parties interact with each other, and a threshold number of nodes can be used to reconstruct the secret value when needed, thus solving secure real-number multiplication tasks.

(3) The Helib library proposed by Halevi and Shoup is a homomorphic encryption library that primarily implements the Brakerski-Gentry-Vaikuntanathan (BGV) homomorphic encryption scheme. Data is first encrypted locally using a homomorphic encryption algorithm, then secure real-number multiplication tasks are executed, and finally, the results can be decrypted using a private key to address privacy protection computation issues.

However, both the Obliv-C framework and the ABY framework have general secure real-number multiplication schemes based on garbled circuits. While the garbled circuit technology can support secure real-number multiplication, these schemes require the construction of a large number of circuits, leading to high computational and space complexity and low computational efficiency. Additionally, this technology is fundamentally aimed at Boolean operations, which presents precision issues in handling floating-point numbers, making it less practical. The MP-SPDZ framework and Crypten framework, based on the idea of secret sharing, hide the true values of numbers from two parties by dividing the values into several shares. This ensures that the secret value can only be reconstructed when a sufficient number of participants come together. However, these schemes involve extensive message exchanges among multiple parties, resulting in low communication efficiency. The Helib library employs a homomorphic encryption scheme, which involves computations on ciphertext encrypted with a public key and then decrypting the results with a private key. While it ensures the security of the computation results, it suffers from computational storage and communication inefficiencies due to the complexity of ciphertext computations and reliance on third-party cloud platforms for computation. Additionally, if the third-party cloud platform is attacked, it poses a risk of data leakage.

### SUMMARY

An objective of the present disclosure is to provide a secure real-number multiplication method and apparatus based on scale transformation, which can improve computational efficiency, communication efficiency, and computational accuracy, without relying on third-party cloud platforms, thereby further ensuring security.

To achieve the above objectives, the present disclosure provides the following solution:

In a first aspect, the present disclosure provides a secure real-number multiplication method based on scale transformation, applied in scenarios in which two participants perform secure real-number multiplication, where the secure real-number multiplication method based on scale transformation includes:
receiving, by a first participant, a secure two-party real-number multiplication request sent by a computation requester, and determining a first private input value based on the secure two-party real-number multiplication request;
receiving, by a second participant, a secure two-party real-number multiplication request sent by the computation requester, and determining a second private input value based on the secure two-party real-number multiplication request;
negotiating and determining, by the first participant and the second participant, a positive integer m that is greater than or equal to 2;
splitting, by the first participant, the first private input value into m distinct first random positive numbers, forming a first private vector from the m distinct first random positive numbers, and generating a first private input matrix with 1 row and m columns based on the first private vector, where a sum of the m distinct first random positive numbers equals the first private input value;
splitting, by the second participant, the second private input value into m distinct second random positive numbers, forming a second private vector from the m distinct second random positive numbers, and generating a second private input matrix with m rows and m columns based on the second private vector, where a sum of the m distinct second random positive numbers equals the second private input value;
computing, by the first participant that uses the first private input matrix as input and the second participant that uses the second private input matrix as input, a first private output matrix and a second private output matrix by utilizing a Secure Two-Party Matrix Multiplication (S2PM) protocol based on a secure data disguising technology;
calculating, by the first participant, a sum of elements in the first private output matrix to obtain a first private output value;
calculating, by the second participant, a sum of elements in the second private output matrix to obtain a second private output value; and
sending, by the first participant, the first private output value to the computation requester; sending, by the second participant, the second private output value to the computation requester; and calculating, by the computation requester, a sum of the first private output value and the second private output value to obtain a secure two-party real-number multiplication result.

In a second aspect, the present disclosure provides a secure real-number multiplication method based on scale transformation, applied in scenarios in which two participants perform secure real-number multiplication, where the secure real-number multiplication method based on scale transformation includes:
receiving, by a first participant, a secure two-party real-number multiplication request sent by a computation requester, and determining a first private input value based on the secure two-party real-number multiplication request;
receiving, by a second participant, a secure two-party real-number multiplication request sent by the computation requester, and determining a second private input value based on the secure two-party real-number multiplication request;
negotiating and determining, by the first participant and the second participant, a positive integer m that is greater than or equal to 2;
splitting, by the first participant, the first private input value into m distinct first random positive numbers, forming a first private vector from the m distinct first random positive numbers, and generating a first private input matrix with 1 row and m columns based on the first private vector, where a sum of the m distinct first random positive numbers equals the first private input value;
splitting, by the second participant, the second private input value into m distinct second random positive numbers, forming a second private vector from the m distinct second random positive numbers, and generating a second private input matrix with m rows and m columns based on the second private vector, where a sum of the m distinct second random positive numbers equals the second private input value;
splitting, by the second participant, the second private input matrix by columns to obtain m third private input matrices, each with m rows and 1 column;
for each third private input matrix, computing, by the first participant that uses the first private input matrix as input and the second participant that uses the third private input matrix as input, a first private value and a second private value by utilizing a Secure Two-Party Matrix Multiplication (S2PM) protocol based on a secure data disguising technology;
calculating, by the first participant, a sum of m first private values to obtain a first private output value;
calculating, by the second participant, a sum of m second private values to obtain a second private output value; and
sending, by the first participant, the first private output value to the computation requester; sending, by the second participant, the second private output value to the computation requester; and calculating, by the computation requester, a sum of the first private output value and the second private output value to obtain a secure two-party real-number multiplication result.

In a third aspect, the present disclosure provides a secure real-number multiplication method based on scale transformation, applied in scenarios in which more than two participants perform secure real-number multiplications, where the secure real-number multiplication method based on scale transformation includes:
receiving, by an n-th participant, a secure multi-party real-number multiplication request sent by a computation requester, and determining an n-th private input value based on the secure multi-party real-number multiplication request, where n=1, 2, . . . , N, and N is the number of participants;
setting i=1;
for layer i of a loop, determining i+1 participants involved in the layer i of the loop, where the i+1 participants include a first participant to an (i+1)-th participant, and i=1, 2, . . . , N−1;
computing, by a j-th participant and the (i+1)-th participant that use a j-th private input value and an (i+1)-th private input value as inputs, a j-th private output value and an (i+1)-th private output value by utilizing the secure real-number multiplication method based on scale transformation as described in claim 1 or claim 4, where j=1, 2, . . . , i;
determining whether i equals N−1;
if yes, using the j-th private output value as a final j-th private output value and a sum of all j-th private output values and the (i+1)-th private output value as a final (i+1)-th private output value; sending, by the n-th participant, a final n-th private output value to the computation requester; and calculating, by the computation requester, a sum of N final private output values, to obtain a secure multi-party real-number multiplication result; and
if not, using the j-th private output value as a j-th private input value and a sum of all j-th private output values and the (i+1)-th private output value as an (i+1)-th private input value, incrementing i by 1, and returning to the step of “determining i+1 participants involved in the layer i of the loop”.

In a fourth aspect, the present disclosure provides a secure real-number multiplication method based on scale transformation, applied in scenarios in which more than two participants perform secure real-number multiplications, where the secure real-number multiplication method based on scale transformation includes:
receiving, by an n-th participant, a secure multi-party real-number multiplication request sent by a computation requester, and determining an n-th private input value based on the secure multi-party real-number multiplication request, where n=1, 2, . . . , N, and N is the number of participants;
negotiating and determining, by the N participants, a positive integer m that is greater than or equal to 2;
splitting, by the n-th participant, the n-th private input value into m distinct n-th random positive numbers, forming an n-th private vector from the m distinct n-th random positive numbers, and generating an n-th private input matrix based on the n-th private vector, where a sum of the m distinct n-th random positive numbers equals the n-th private input value;
with N private input matrices as inputs, computing, by the N participants, N private output matrices by utilizing a Secure Two-Party Matrix Multiplication (S2PM) protocol based on a secure data disguising technology, where the private output matrix of the n-th participant is an n-th private output matrix;
calculating, by the n-th participant, a sum of elements in the n-th private output matrix to obtain an n-th private output value; and
sending, by the n-th participant, the n-th private output value to the computation requester;
and calculating, by the computation requester, a sum of N private output values, to obtain a secure multi-party real-number multiplication result.

In a fifth aspect, the present disclosure provides a secure real-number multiplication apparatus based on scale transformation, applied in scenarios in which two participants perform secure real-number multiplication, where the secure real-number multiplication apparatus based on scale transformation includes: a computation requester, as well as a task acquisition module, a secure computation module, a rule generation module, a consensus computation module, and a data transmission module corresponding to each participant;
the task acquisition module is configured to receive a secure two-party real-number multiplication request sent by the computation requester;
the secure computation module, the rule generation module, and the consensus computation module are configured to work together to execute the above secure real-number multiplication method based on scale transformation, to obtain a private output value of the participant;
the data transmission module is configured to send the private output value to the computation requester; and
the computation requester is configured to calculate a sum of private output values of both participants, to obtain a secure two-party real-number multiplication result.

In a sixth aspect, the present disclosure provides a secure real-number multiplication apparatus based on scale transformation, applied in scenarios in which more than two participants perform secure real-number multiplication, where the secure real-number multiplication apparatus based on scale transformation includes: a computation requester, as well as a task acquisition module, a secure computation module, a rule generation module, a consensus computation module, and a data transmission module corresponding to each participant;
the task acquisition module is configured to receive a secure multi-party real-number multiplication request sent by the computation requester;
the secure computation module, the rule generation module, and the consensus computation module are configured to work together to execute the above secure real-number multiplication method based on scale transformation, to obtain a private output value of the participant;
the data transmission module is configured to send the private output value to the computation requester; and
the computation requester is configured to calculate a sum of private output values of all participants, to obtain a secure multi-party real-number multiplication result.

According to specific examples provided in present disclosure, present disclosure discloses the following technical effects:

The present disclosure provides a secure real-number multiplication method and apparatus based on scale transformation. By introducing scale transformation, private input values of each participant can be converted into private input matrices. Subsequently, it only requires invoking a Secure Two-Party Matrix Multiplication (S2PM) protocol based on a secure data disguising technology to obtain private output matrices for each participant through parallel computations. Then, dimensions are reduced to obtain private output values of each participant. This approach addresses the issue of low communication efficiency caused by the need for extensive information exchange and does not require the introduction of any keys or computations in a ciphertext space. It balances higher computational accuracy with higher computational efficiency and does not rely on third-party cloud platforms. Thus, the present disclosure can enhance computational efficiency, communication efficiency, and computational accuracy while further ensuring security, and does not rely on third-party platforms, thereby further ensuring security.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic diagram of a secure two-party real-number multiplication problem according to the present disclosure;

FIG. 2 is a schematic flowchart of a Secure 2-Party Real-Number Multiplication (S2PRM) protocol according to the present disclosure;

FIG. 3 is a schematic diagram of a secure two-party matrix multiplication problem according to the present disclosure;

FIG. 4 is a schematic diagram of a secure data disguising technology according to the present disclosure;

FIG. 5 is a flowchart of a Secure Two-Party Matrix Multiplication (S2PM) protocol according to the present disclosure;

FIG. 6 is a schematic diagram of a secure n-party real-number multiplication according to the present disclosure;

FIG. 7 is a schematic flowchart of a Secure N-Party Real-Number Multiplication (SNPRM) protocol according to the present disclosure;

FIG. 8 is a schematic flowchart of another SNPRM protocol according to the present disclosure; and

FIG. 9 is a schematic diagram of an implementation apparatus of a S2PRM protocol applied to distributed computation participants according to the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

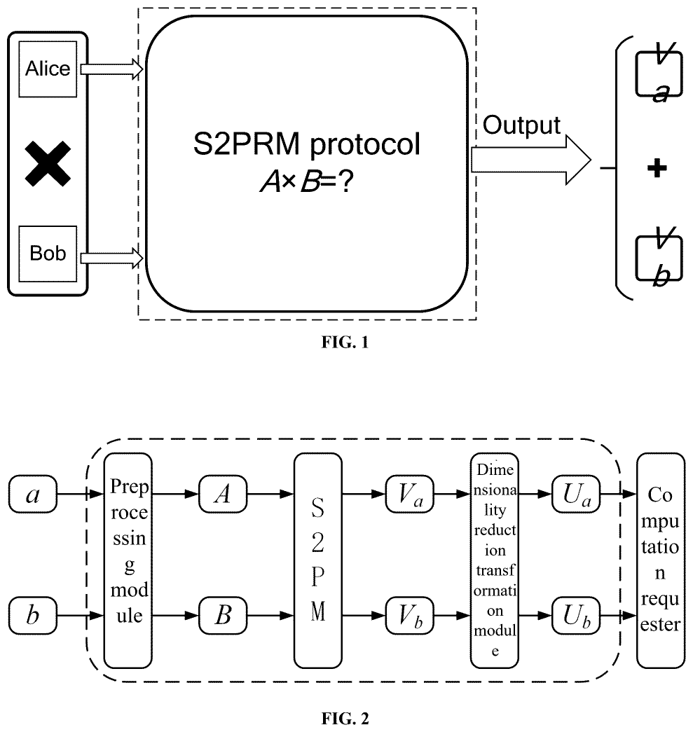

The Secure 2-Party Real-Number Multiplication (S2PRM) protocol refers to the following: Assume there are two mutually distrustful participants, P1 and P2, holding secret values x and y, respectively. Using x and y as inputs, both parties jointly execute an S2PRM protocol f(x,y)=Output(v₁,v₂)=x×y, where the two participants ultimately obtain corresponding outputs v₁ and v₂, respectively, satisfying v₁+v₂=x×y. Throughout the computation process, each participant knows only input and output data involved in their own computation process, and cannot obtain any intermediate computation results of the other participant. As shown in FIG. 1, the secure two-party real-number multiplication problem is defined as follows:

Given two participants, Alice and Bob, who are independent and distrustful of each other, Alice holds private data a stored only on her computing node, while Bob holds private data b stored only on his computing node. The two participants jointly execute an S2PRM protocol f(a,b)=a×b=Uₐ+U_{b}, where two participants ultimately obtain corresponding outputs Uₐ and U_{b}, respectively, which are sent to a computation requester to obtain a desired secure two-party real-number multiplication result. During the computation process, each participant can only access their own input and output information and cannot obtain any intermediate computation results or private data information held by the other participant.

Existing solutions to the secure two-party real-number multiplication problem often employ computational frameworks developed based on traditional basic cryptographic primitives such as homomorphic encryption, secret sharing, and garbled circuits. These methods depend on computations in ciphertext space with extremely high time and space complexity, leading to low practicality and insufficient computational efficiency. Moreover, these methods often rely on outsourced cloud service systems for implementation. If the third-party cloud service system has low trustworthiness or suffers attacks from malicious nodes, it may result in the leakage of intermediate computation results or critical key information, further posing security risks of privacy leakage for original data holders.

The present disclosure primarily focuses on the secure real-number multiplication problem, providing an efficient, secure, and reliable privacy-preserving numerical computation method. At this point, the design of the S2PRM protocol is illustrated in FIG. 2.

The secure two-party real-number multiplication problem typically arises in application scenarios such as the privatization of activation functions in logistic regression and multi-layer perceptrons, as well as privacy-preserving vector bit multiplication and matrix bit multiplication, making it of broad research value. Therefore, an initial input of node Alice in this protocol is set to value a, and an initial input of node Bob is set to value b. Based on this, an efficient parallel S2PRM protocol is proposed, as shown in FIG. 2. The protocol process is as follows:

### (1) Preprocessing:

Step 1: Participant node Alice and participant node Bob jointly negotiate a positive integer m≥2 and locally split respective private input values a and b into m distinct random positive numbers, forming private vectors α=(α₁, α₂, . . . , αₘ)∈R^{m} and β=(β₁, β₂, . . . , βₘ)∈R^{m}, where

$$a = {\sum }_{i = 1}^{m} {α}_{i} and b = {\sum }_{i = 1}^{m} {β}_{i} ,$$

with αᵢ and βᵢ being the i-th random positive number.

Step 2: The participant node Alice converts the private vector a into a row of a matrix, resulting in a private input matrix A∈R^{1×m}. The participant node Bob performs a full permutation of the m elements in the private vector β and converts each permutation into a random sorted vector, resulting in s=m! random sorted vectors. This process is represented as B→{θᵢ=perms(β₁,β₂, . . . , βₘ)|(i=1, 2, . . . , s)}, where the perms function denotes a full permutation operation on the m elements (β₁, β₂, . . . , βₘ). Subsequently, m vectors θⱼ (j∈{1, 2, . . . , s}) are randomly selected from {θ₁˜θₛ} to serve as row vectors that jointly form a private input matrix B∈R^{m×m}.

### (2) Formal Computation:

Step 3: The participant node Alice and the participant node Bob input the respective private input matrix A∈R^{1×m} and private input matrix B∈R^{m×m} based on a Secure Two-Party Matrix Multiplication (S2PM) protocol, to perform a round of secure two-party matrix multiplication f_{S2PM}(A,B)=A×B. After the execution of the S2PM protocol, f_{S2PM} (A,B) is split into two results Vₐ, V_{b}∈R^{1×m} based on the secure data disguising technology, which are sent to the participant node Alice and the participant node Bob as their private output matrices. These two private output matrices satisfy the relationship f_{S2PM} (A,B)=Vₐ+Vₚ=A×B.

### (3) Dimensionality Reduction Transformation:

Step 4: After the participant node Alice and the participant node Bob obtain the private output matrices Vₐ,V_{b}∈R^{1×m}, each locally sums the m elements of their private output matrices locally to obtain private output values Uₐ=sum(Vₐ) and U_{b}=sum(V_{b}), and the two participants send Uₐ and U_{b} to a computation requester, who aggregates the received private output values to obtain f(a,b)=Uₐ+U_{b}=a×b.

It can be readily verified that

$${U}_{a} + {U}_{b} = sum ( {V}_{a} ) + sum ( {V}_{b} ) = sum ( {V}_{a} + {V}_{b} ) = sum ( A \times B ) = {Σ}_{i = 1}^{m} {α}_{i} \times {Σ}_{i = 1}^{m} {β}_{i} = a \times b .$$

In step 3, the Secure Two-Party Matrix Multiplication (S2PM) protocol refers to the following: Assume there are two mutually distrustful participants, P1 and P2, holding secret matrices x and y, respectively. The two participants jointly execute an S2PM protocol f(x,y)=Output(v₁,v₂)=x·y, where the participants ultimately obtain the corresponding outputs v₁ and v₂, respectively, satisfying v₁+v₂=x·y. Throughout the computation process, each participant knows only input and output data involved in their own computation process, and cannot obtain any intermediate computation results of the other participant. As shown in FIG. 3, the secure two-party matrix multiplication problem is defined as follows:

Given two computation participants, Alice and Bob, who are independent and distrustful of each other, Alice holds an n×s-dimensional private data matrix A stored only on her computing node, while Bob holds an s×m-dimensional private data matrix B stored only on his computing node. The two participants wish to jointly execute an S2PM protocol to achieve f(A,B)=AB=Vₐ+V_{b}, where the two participants ultimately obtain their corresponding n×m-dimensional output matrices Vₐ and V_{b}, respectively, and send the output matrices to the computation requester, who aggregates the received matrices to obtain a desired secure two-party matrix product result. During the computation process, each participant can only access their own input and output information and cannot obtain any intermediate computation results or data information held by the other participant.

In most cases, more than one interaction procedure needs to be performed to ensure secure computation in a multi-party computation process. Therefore, how to ensure safety of intermediate results is an inevitable problem. For example, when using the two-party matrix product result A×B as an intermediate computation result, both the participant node Alice and the participant node Bob, upon obtaining the final matrix A×B, could potentially deduce data information of the other party. Therefore, in the privacy-preserving computation process, it is essential to ensure not only the security of the initial input data but also the security of the intermediate computation results. To address this issue, the present disclosure introduces a secure data disguising technology.

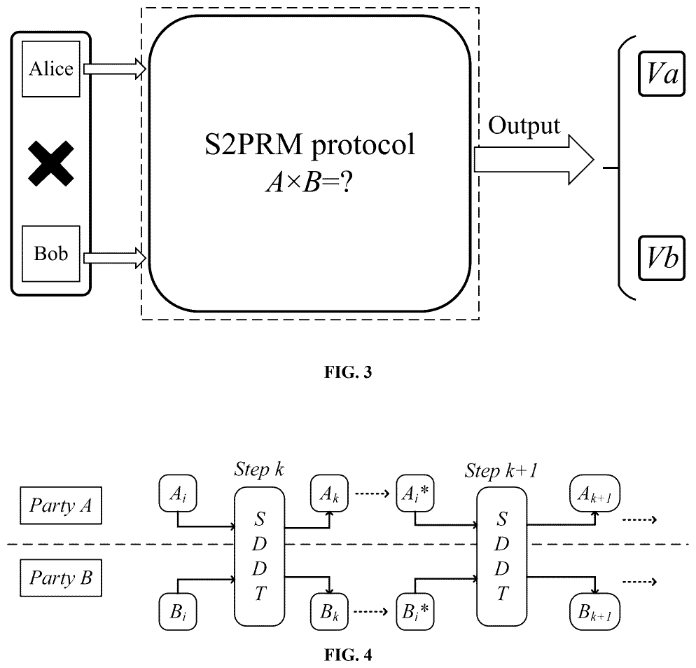

The secure data disguising technology is a data protection method used to safeguard intermediate results in multi-party secure computations. By reasonably constructing computation protocols, it randomly splits the computation results, allowing outputs of multiple parties to collectively form a true target computation result through linear combination, ultimately achieving a one-time pad data privacy protection effect. The present disclosure proposes a secure data disguising technology that decomposes an arbitrary multi-item operation into a new multi-item addition to obfuscate intermediate computation results. In the present disclosure, taking the two-party operation type as an example, the principle of the secure data disguising technology is illustrated in FIG. 4. It is assumed that an intermediate result is Sₖ=Fₖ(Aᵢ,Bᵢ), where Fₖ is a target computation function for the k-th step, Aᵢ is private input data belonging to node Alice for the k-th step, and Bᵢ is private input data belonging to node Bob for the k-th step. During the execution of the k-th step of the multi-party secure computation protocol, the intermediate result Sₖ will strictly adhere to the following constraints: node Alice only knows her own computation result Aₖ, node Bob only knows his own computation result Bk, and Aₖ+Bk=Sₖ. The formula [Aᵢ:Bᵢ]→[Aₖ:Bₖ|Aₖ+Bₖ=Fₖ(Aᵢ,Bᵢ)] represents the process of passing intermediate values, during which node Alice and node Bob are not allowed to exchange data information with each other, including Aₖ and Bₖ split from the intermediate result. Similarly, for the (k+1)-th step, inputs

$${A}_{i}^{*} = {A}_{k} and {B}_{i}^{*} = {B}_{k} .$$

$$The outputs {A}_{k + 1} and {B}_{k + 1} satisfy {S}_{k + 1} = {F}_{k + 1} ( {A}_{i}^{*} , {B}_{i}^{*} ) = {A}_{k + 1} + {B}_{k + 1} ,$$

are derived from the outputs Aₖ and Bₖ of the k-th step from node Alice and node Bob, respectively, where

$${A}_{i}^{*} and {B}_{i}^{*}$$

with node Alice only knowing her own computation result Aₖ₊₁ and node Bob only knowing his own computation result Bₖ₊₁. Therefore, as long as it is ensured that the intermediate result is divided into two random data items and separately stored in the two participants at each step during computation, it can be ensured that no one can reversely deduce the original data item from disguised and encrypted data, so that the whole process of privacy computing has high safety.

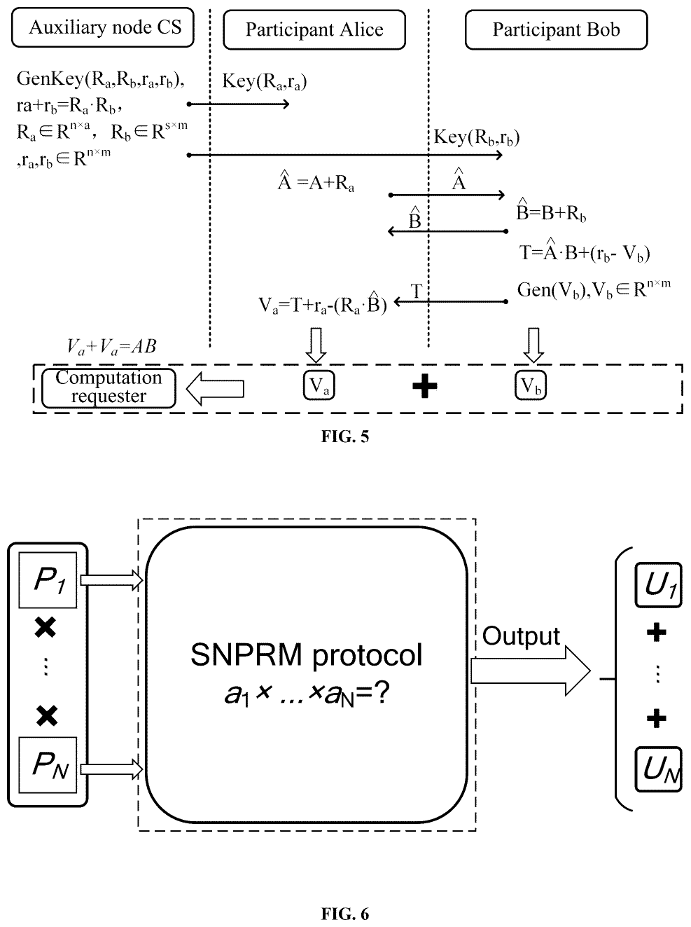

As shown in FIG. 5, the present disclosure proposes an S2PM protocol based on the secure data disguising technology, with the protocol process as follows:

Step 1: An auxiliary node, also referred to as a commodity server (CS) node, generates two random matrix pairs: an n×s-dimensional random matrix Rₐ, an s×m-dimensional random matrix R_{b}, and two n×m-dimensional random matrices rₐ and r_{b}, where these random matrices strictly satisfy the following constraint: rₐ+r_{b}=Rₐ·R_{b}. Then, the auxiliary node sends a random matrix pair (Rₐ, rₐ) to a participant node Alice, and a random matrix pair (R_{b}, r_{b}) to a participant node Bob.

Step 2: After receiving the corresponding random matrix pair (Rₐ, rₐ), the participant node Alice computes Â=A+Rₐ internally, and sends it to the participant node Bob.

Step 3: After receiving the corresponding random matrix pair (R_{b}, r_{b}), the participant node Bob computes \hat{B}=B+R_{b} internally, and sends it to the participant node Alice.

Step 4: After receiving the matrix Â from the participant node Alice, the participant node Bob secretly generates a random matrix V_{b}∈R^{n×m} internally, secretly computes a matrix T=Â·B+(r_{b}−V_{b}) locally, and sends the matrix to the participant node Alice.

Step 5: After receiving T, the node of the participant Alice secretly computes a matrix Vₐ=T+rₐ−(Rₐ·\hat{B}) locally.

Step 6: The participant node Alice and the participant node Bob send, to a computation requester, corresponding results Vₐ and V_{b} that are obtained through obfuscation and splitting, and the computation requester obtains a final product AB=Vₐ+V_{b} through summarization. It can be readily verified that:

$${V}_{a} + {V}_{b} = [ ( \hat{A} \cdot B + ( {r}_{b} - {V}_{b} ) ) + {r}_{a} - ( {R}_{a} \cdot \hat{B} ) ] + {V}_{b} = [ ( A \cdot B - {V}_{b} ) + ( {r}_{a} + {r}_{b} - {R}_{a} \cdot {R}_{b} ) ] + {V}_{b} = A \cdot B .$$

Based on the foregoing protocol process, the present disclosure provides a secure real-number multiplication method based on scale transformation, applied in scenarios where two participants perform secure real-number multiplication. The secure real-number multiplication method based on scale transformation includes the following steps:

(1) A first participant receives a secure two-party real-number multiplication request sent by a computation requester, and determines a first private input value based on the secure two-party real-number multiplication request.

(2) A second participant receives a secure two-party real-number multiplication request sent by the computation requester, and determines a second private input value based on the secure two-party real-number multiplication request.

(3) The first participant and the second participant negotiates and determines a positive integer m that is greater than or equal to 2.

(4) The first participant splits the first private input value into m distinct first random positive numbers, forms a first private vector from the m distinct first random positive numbers, and generates a first private input matrix with 1 row and m columns based on the first private vector, where a sum of the m distinct first random positive numbers equals the first private input value.

Said generating the first private input matrix with 1 row and m columns based on the first private vector specifically includes: using the first private vector as the first private input matrix with 1 row and m columns.

(5) The second participant splits the second private input value into m distinct second random positive numbers, forms a second private vector from the m distinct second random positive numbers, and generates a second private input matrix with m rows and m columns based on the second private vector, where a sum of the m distinct second random positive numbers equals the second private input value.

Said generating the second private input matrix with m rows and m columns based on the second private vector specifically includes: performing a full permutation of each element in the second private vector to obtain a plurality of permutations, with each permutation corresponding to a random sorted vector; and randomly selecting m random sorted vectors to form the second private input matrix with m rows and m columns, where the number of permutations is factorial of m.

(6) The first participant, which uses the first private input matrix as input, and the second participant, which uses the second private input matrix as input, compute a first private output matrix and a second private output matrix by utilizing an S2PM protocol based on a secure data disguising technology.

(7) The first participant calculates a sum of elements in the first private output matrix to obtain a first private output value.

(8) The second participant calculates a sum of elements in the second private output matrix to obtain a second private output value.

(9) The first participant sends the first private output value to the computation requester; the second participant sends the second private output value to the computation requester; and the computation requester calculates a sum of the first private output value and the second private output value to obtain a secure two-party real-number multiplication result.

The first participant, which uses the first private input matrix as input, and the second participant, which uses the second private input matrix as input, computing the first private output matrix and the second private output matrix by utilizing the S2PM protocol based on the secure data disguising technology specifically includes:

(1) An auxiliary node generates a first random matrix, a second random matrix, a third random matrix, and a fourth random matrix, sends the first random matrix and the third random matrix to the first participant, and sends the second random matrix and the fourth random matrix to the second participant, where a product of the first random matrix and the second random matrix equals a sum of the third random matrix and the fourth random matrix.

(2) The first participant calculates a sum of the first private input matrix and the first random matrix to obtain a first sum matrix, and sends the first sum matrix to the second participant.

(3) The second participant calculates a sum of the second private input matrix and the second random matrix to obtain a second sum matrix, and sends the second sum matrix to the first participant.

(4) The second participant randomly generates the second private output matrix, calculates a first product of the first sum matrix and the second private input matrix, calculates a difference between the fourth random matrix and the second private output matrix, calculates a sum of the first product and the calculated difference to obtain a computation matrix, and sends the computation matrix to the first participant.

(5) The first participant calculates a sum of the computation matrix and the third random matrix, calculates a second product of the first random matrix and the second sum matrix, and calculates a difference between the calculated sum and the second product to obtain the first private output matrix.

The present disclosure further provides an alternative scheme for the S2PRM protocol, with the protocol process as follows:

Step 1: Participant node Alice and participant node Bob jointly negotiate a positive integer m≥2 and locally split respective private input values into m distinct random positive numbers, forming private vectors

$$α = ( {α}_{1} , {α}_{2} , … , {α}_{m} ) ∈ {R}^{m} and β = ( {β}_{1} , {β}_{2} , … , {β}_{m} ) ∈ {R}^{m} ,$$

$$where a = {\sum }_{i = 1}^{m} {α}_{i} and b = {\sum }_{i = 1}^{m} {β}_{i} .$$

Step 2: The participant node Bob performs a full permutation of the m elements in the private vector β and converts each permutation into a random sorted vector, resulting in s=m! random sorted vectors. This process is represented as β [symbol] {θᵢ=perms(β₁, β₂, . . . , βₘ)|(i=1, 2, . . . , s)}, where the perms function denotes a full permutation operation on the m elements (β₁, β₂, . . . , βₘ). Subsequently, m vectors θⱼ (j∈{1, 2, . . . , s}) are randomly selected from {θ₁˜θₛ} to serve as row vectors that jointly form a private input matrix B∈R^{m×m} Then, the participant node Bob extracts all column vectors θ₁*, θ₂*, . . . , θₘ* from the matrix B, where the column vector

$${θ}_{i}^{*} = {( {θ}_{1 i}^{*} , {θ}_{2 i}^{*} … {θ}_{mi}^{*} )}^{T} ( i ∈ \{ 1 , 2 , … , m \} ) :$$

$$B = [ \begin{matrix}{θ}_{11}^{*} & … & {θ}_{1 m}^{*} \\ ⋮ & ⋱ & ⋮ \\ {θ}_{m 1}^{*} & … & {θ}_{mm}^{*}\end{matrix} ] = [ \begin{matrix}{θ}_{1}^{*} & {θ}_{2}^{*} & … & {θ}_{m}^{*}\end{matrix} ]$$

Step 3: The participant node Alice and the participant node Bob perform m rounds of secure two-party matrix multiplication based on the S2PM protocol, where in an i (1≤i≥m)-th round, the two participants input their respective private input matrices α∈R^{1×m} and

$${θ}_{i}^{*} ∈ {R}^{m \times 1} to compute {f}_{S 2 P M} ( a , {θ}_{i}^{*} ) = a {θ}_{i}^{*} .$$

that round

$${f}_{S 2 PM} ( a , {θ}_{i}^{*} )$$

is Spilt Into two numerical results Vₐᵢ and V_{bi} based on the secure data disguising technology, which are sent to the participant node Alice and the participant node Bob as their private values, where the two private values satisfy the following relationship:

$${f}_{S 2 PM} ( a , {θ}_{i}^{*} ) = {V}_{a i} + {V}_{b i} = a {θ}_{i}^{*} .$$

Step 4: After the participant node Alice and the participant node Bob obtain respective private values Vₐᵢ and V_{bi} (1≤i≤m), each performs a summation operation locally to obtain private output values

$${U}_{a} = {\sum }_{i = 1}^{m} {V}_{a i} and {U}_{b} = {\sum }_{i = 1}^{m} {V}_{b i} ,$$

and the two participants send Uₐ and U_{b} to a computation requester, who aggregates the received private output values to obtain f(a,b)=Uₐ+U_{b}=a×b.

It can be readily verified that

$${U}_{a} + {U}_{b} = {\sum }_{i = 1}^{m} {V}_{a i} + {\sum }_{i = 1}^{m} {V}_{b i} = {\sum }_{i = 1}^{m} a {θ}_{i}^{*} = {\sum }_{i = 1}^{m} {α}_{i} \times {\sum }_{i = 1}^{m} {β}_{i} = a \times b .$$

Based on the foregoing protocol process, the present disclosure provides a secure real-number multiplication method based on scale transformation, applied in scenarios where two participants perform secure real-number multiplication. The secure real-number multiplication method based on scale transformation includes the following steps:

(1) A first participant receives a secure two-party real-number multiplication request sent by a computation requester, and determines a first private input value based on the secure two-party real-number multiplication request.

(2) A second participant receives a secure two-party real-number multiplication request sent by the computation requester, and determines a second private input value based on the secure two-party real-number multiplication request.

(3) The first participant and the second participant negotiates and determines a positive integer m that is greater than or equal to 2.

(4) The first participant splits the first private input value into m distinct first random positive numbers, forms a first private vector from the m distinct first random positive numbers, and generates a first private input matrix with 1 row and m columns based on the first private vector, where a sum of the m distinct first random positive numbers equals the first private input value.

(5) The second participant splits the second private input value into m distinct second random positive numbers, forms a second private vector from the m distinct second random positive numbers, and generates a second private input matrix with m rows and m columns based on the second private vector, where a sum of the m distinct second random positive numbers equals the second private input value.

(6) The second participant splits the second private input matrix by columns to obtain m third private input matrices, each with m rows and 1 column.

(7) For each third private input matrix, the first participant that uses the first private input matrix as input and the second participant that uses the third private input matrix as input compute a first private value and a second private value by utilizing an S2PM protocol based on a secure data disguising technology.

(8) The first participant calculates a sum of m first private values to obtain a first private output value.

(9) The second participant calculates a sum of m second private values to obtain a second private output value.

(10) The first participant sends the first private output value to the computation requester; the second participant sends the second private output value to the computation requester; and the computation requester calculates a sum of the first private output value and the second private output value to obtain a secure two-party real-number multiplication result.

The present disclosure designs an S2PRM protocol based on the concept of secure data disguising technology. This protocol does not require the introduction of any keys and, due to its inherent characteristics of disguising encrypted data in the real number domain, ensures “one-time pad” security while also balancing higher computational accuracy and lower computational cost requirements. By transforming values into matrices through scale transformation and leveraging the distributive and associative properties of real-number multiplication, it guarantees that only one round of the S2PM protocol needs to be invoked to obtain the final result through parallel computing, addressing the issue of low communication efficiency caused by the extensive information exchange required in the secret sharing technology. The S2PRM protocol proposed in the present disclosure, by randomly splitting each value into m distinct positive numbers, ensures that after the S2PM protocol is executed to obtain private output matrix results of each participant, the original data of each participant remains secure even if there is partial data leakage (with the number of leaked items not exceeding m). Additionally, this protocol does not rely on third-party cloud platforms, thus mitigating the risk of data leakage due to attacks on third-party cloud platforms associated with the homomorphic encryption technology.

A Secure N-Party Real-Number Multiplication (SNPRM) protocol refers to the following: Assume there are N mutually independent and distrustful computation participants P₁, P₂, . . . , P_{N}, each holding a secret value a₁, a₂, . . . , a_{N}. With a₁, a₂, . . . , a_{N} as inputs, the participants jointly execute an SNPRM protocol f(a₁, a₂, . . . , a_{N})=Output(v₁, v₂, . . . , v_{N})=a₁×a₂× . . . ×a_{N}, where each participant ultimately obtains their corresponding outputs v₁, v₂, . . . , v_{N}, satisfying

$${\sum }_{i = 1}^{i = N} {v}_{i} = {\prod }_{i = 1}^{i = N} {a}_{i} .$$

Throughout the computation process, each participant knows only input and output data involved in their own computation process, and cannot obtain any intermediate computation results of other participants. As shown in FIG. 6, the secure multi-party real-number multiplication problem is defined as follows:

Given N computation participants P₁, P₂, . . . , P_{N}, who are independent and distrustful of each other, each participant holds private data stored only on their own computing nodes, namely a₁, a₂, . . . , a_{N}. The N participants jointly execute an SNPRM protocol f(a₁, a₂, . . . , a_{N})=a₁×a₂× . . . ×a_{N}=U₁+U₂+ . . . +U_{N}, where each participant ultimately obtains their corresponding outputs U₁, U₂, . . . , U_{N}, which are sent to the computation requester to obtain a desired secure multi-party real-number multiplication result. During the computation process, each participant can only access their own input and output information and cannot obtain any intermediate computation results or private data information held by other participants.

In terms of scalability, most existing solutions perform well in secure two-party real-number multiplication but encounter many issues when extended to secure multi-party real-number multiplication. The Obliv-C framework and the ABY framework, which use garbled circuit schemes, face challenges with large-scale data computations, leading to massive circuit sizes and high computational and communication overheads. Secret sharing schemes generate a significant amount of information exchange when handling secure multi-party real-number multiplication, resulting in low communication efficiency. Homomorphic encryption, due to its reliance on the encryption technology, incurs high computational costs when involving secure multi-party real-number multiplication.

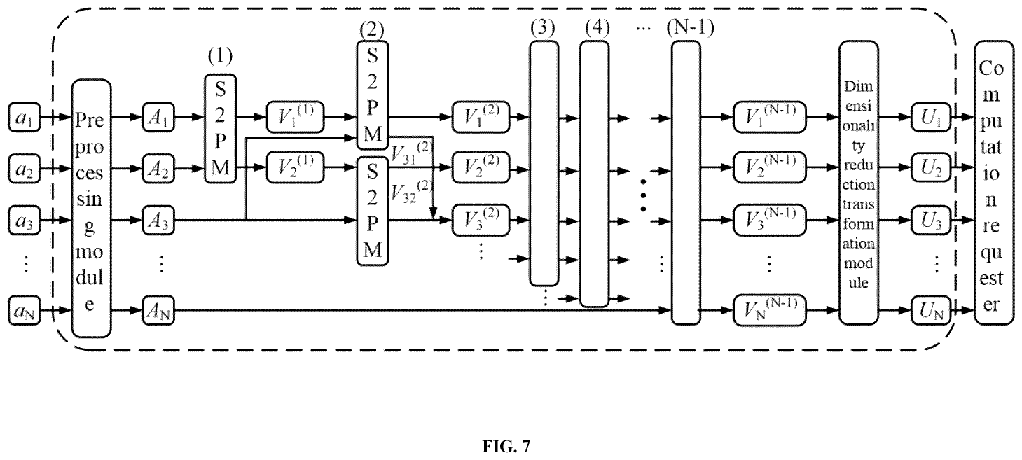

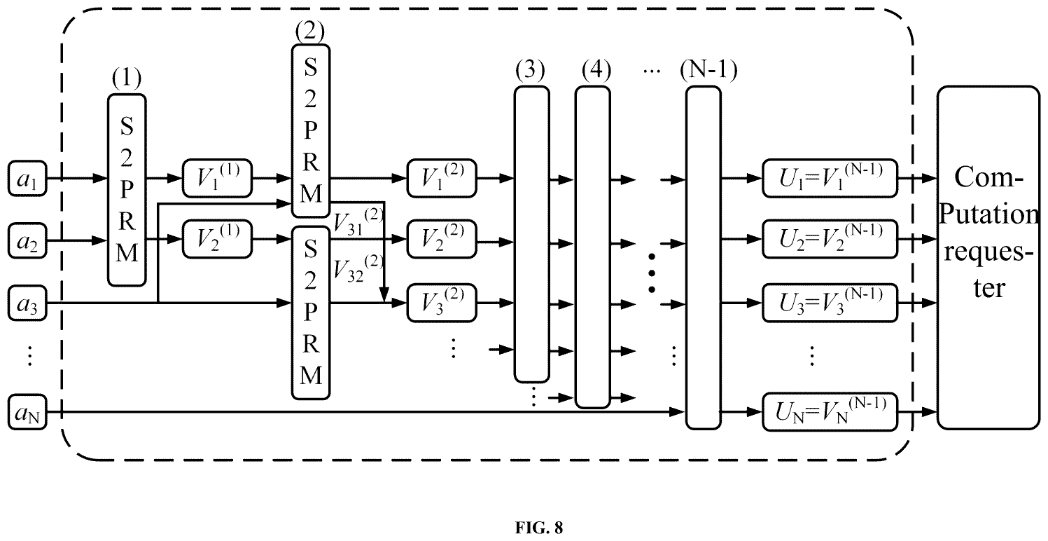

Based on this, as shown in FIG. 7, the present disclosure provides an SNPRM protocol, with the protocol process as follows:

### (1) Preprocessing:

Step 1: All participant jointly negotiate a positive integer m≥2 and locally split their respective private input values into m distinct random positive numbers, forming private vectors θ₁=(θ₁₁, θ₁₂, . . . , θ₁ₘ)∈R^{m}, θ₂=(θ₂₁, θ₂₂, . . . , θ₂ₘ)∈R^{m}, . . . , θ_{N}=(θ_{N1}, θ_{N2}, . . . , θ_{Nm})∈R^{m}.

Step 2: Participant P₁ uses the private vector θ₁ as a row of a matrix, converting it into a private input matrix A₁∈R^{1×m}. For all participants Pᵢ (2≤i≤N), each performs a full permutation of the m elements in θᵢ and converts each permutation into a random sorted vector, resulting in s=m! random sorted vectors. This process is represented as θᵢ [symbol] {θᵢⱼ=perms(θⱼ₁, θⱼ₂, . . . , θⱼₘ)|(j=1, 2, . . . , s)}, where the perms function denotes a full permutation operation on the m elements (θⱼ₁, θⱼ₂, . . . , θⱼₘ). Subsequently, m vectors θᵢⱼ (j∈{1, 2, . . . , s}) are randomly selected from {θᵢ₁˜θᵢₛ} to serve as row vectors that jointly form a private input matrix Aᵢ∈R^{m×m}.

### (2) Formal Computation:

Step 3: Participant P₁ and participant P₂ input the respective private input matrices A₁∈R^{1×m} and A₂∈R^{m×m} based on an S2PM protocol and a secure data disguising technology, to perform layer [symbol] 1 [symbol] secure two-party matrix multiplication

$${f}_{S 2 PM} ( {A}_{1} , {A}_{2} ) = {A}_{1} {A}_{2} = {V}_{1}^{〈 1 〉} + {V}_{2}^{〈 1 〉} , obtaining results {V}_{1}^{〈 1 〉} and {V}_{2}^{〈 1 〉} ∈ {R}^{1 \times m} ,$$

respectively.

Step 4: Execute the following process in a loop for a total of N−2 times: For layer i (1≤i≤N−2) of the loop, based on the secure data disguising technology and the S2PM protocol, the i+2 participants execute a total of i+1 rounds of the S2PM protocol in <i+1> layers (<i> in FIG. 7 indicates layer i). In the j-th round (1≤j≤i+1) of secure two-party matrix multiplication in layer <i+1>, participants Pⱼ and Pᵢ₊₂ input their respective private input matrices

$${V}_{j}^{〈 i 〉} ∈ {R}^{1 \times m} and {A}_{i + 2} ∈ {R}^{m \times m} to compute {f}_{S 2 PM} ( {V}_{j}^{〈 i 〉} , {A}_{i + 2} ) = {V}_{j}^{〈 i 〉} {A}_{i + 2} = {V}_{j}^{〈 i + 1 〉} + {V}_{( i + 2 ) j}^{〈 i + 1 〉} , obtaining results {V}_{j}^{〈 i + 1 〉} and {V}_{( i + 2 ) j}^{〈 i + 1 〉} ∈ {R}^{1 \times m} ,$$

respectively. Subsequently, participant Pᵢ₊₂ locally computes

$${V}_{i + 2}^{〈 i + 1 〉} = {\sum }_{j = 1}^{i + 1} {V}_{( i + 2 ) j}^{〈 i + 1 〉} .$$

### (3) Dimensionality Reduction Transformation:

Step 5: After all the participants Pᵢ (1≤i≤N) obtain their private output matrices

$${V}_{i}^{〈 N - 1 〉} ∈ {R}^{1 \times m} ,$$

each participant locally sums the m elements in the matrix to convert the one-dimensional matrix into a value, ultimately obtaining a private output value

$${U}_{i} = sum ( {V}_{i}^{〈 N - 1 〉} ) .$$

Then, the participants send Uᵢ to a computation requester, who aggregates the received private output values to obtain

$$f ( {a}_{1} , {a}_{2} , … , {a}_{N} ) = {\sum }_{i = 1}^{N} {U}_{i} = {a}_{1} \times {a}_{2} \times … \times {a}_{N} .$$

It can be readily verified that

$${\sum }_{i = 1}^{N} {U}_{i} = {\sum }_{i = 1}^{N} sum ( {V}_{i}^{〈 N - 1 〉} ) = sum ( {\sum }_{i = 1}^{N} {V}_{i}^{〈 N - 1 〉} ) = sum ( {A}_{1} \times {A}_{2} \times … \times {A}_{N} ) = {\sum }_{i = 1}^{m} {θ}_{1 i} \times {\sum }_{i = 1}^{m} {θ}_{2 i} \times … \times {\sum }_{i = 1}^{m} {θ}_{N i} = {a}_{1} \times {a}_{2} \times … \times {a}_{N} .$$

Based on the foregoing protocol process, the present disclosure provides a secure real-number multiplication method based on scale transformation, applied in scenarios where more than two participants perform secure real-number multiplication. The secure real-number multiplication method based on scale transformation includes the following steps:

(1) An n-th participant receives a secure multi-party real-number multiplication request sent by a computation requester, and determines an n-th private input value based on the secure multi-party real-number multiplication request, where n=1, 2, . . . , N, and N is the number of participants.

(2) The N participants negotiates and determines a positive integer m that is greater than or equal to 2.

(3) The n-th participant splits the n-th private input value into m distinct n-th random positive numbers, forms an n-th private vector from the m distinct n-th random positive numbers, and generates an n-th private input matrix based on the n-th private vector, where a sum of the m distinct n-th random positive numbers equals the n-th private input value.

Said generating the n-th private input matrix based on the n-th private vector specifically includes:
when n equals 1, using the n-th private vector as the n-th private input matrix; and
when n is not equal to 1, performing a full permutation of each element in the n-th private vector to obtain a plurality of permutations, with each permutation corresponding to a random sorted vector; and randomly selecting m random sorted vectors to form the n-th private input matrix, where the number of permutations is factorial of m.

(4) With N private input matrices as inputs, the N participants compute N private output matrices by utilizing an S2PM protocol based on a secure data disguising technology, where the private output matrix of the n-th participant is an n-th private output matrix.

(5) The n-th participant calculates a sum of elements in the n-th private output matrix to obtain an n-th private output value.

(6) The n-th participant sends the n-th private output value to the computation requester; and the computation requester calculates a sum of N private output values, to obtain a secure multi-party real-number multiplication result.

Said with the N private input matrices as inputs, the N participants computing the N private output matrices by utilizing the S2PM protocol based on the secure data disguising technology specifically includes:

$$Set i = 1 . \qquad ( 1 )$$

(2) For layer i of a loop, determine i+1 participants involved in the layer i of the loop, where the i+1 participants include a first participant to an (i+1)-th participant, and i=1, 2, . . . , N−1.

(3) A j-th participant and the (i+1)-th participant, which use a j-th private input matrix and an (i+1)-th private input matrix as inputs, compute a j-th intermediate matrix and an (i+1)-th intermediate matrix by utilizing the S2PM protocol based on the secure data disguising technology, where j=1, 2, . . . , i.

(4) Determine whether i equals N−1.

(5) If yes, use the j-th intermediate matrix as a j-th private output matrix and a sum of all j-th intermediate matrices and the (i+1)-th intermediate matrix as an (i+1)-th private output matrix.

(6) If not, use the j-th intermediate matrix as a j-th private input matrix and a sum of all j-th intermediate matrices and the (i+1)-th intermediate matrix as an (i+1)-th private input matrix, increment i by 1, and return to the step of “determining i+1 participants involved in the layer i of the loop”.

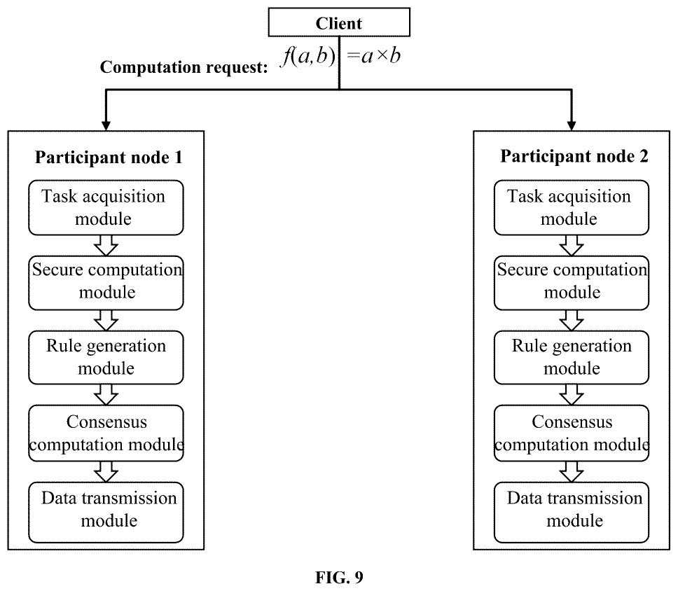

The present disclosure further provides an alternative scheme for the SNPRM protocol, as shown in FIG. 8, with the protocol process as follows:

Step 1: Participant P₁ and participant P₂ input the respective private values a₁ and a₂ based on an S2PRM protocol, to perform layer- [symbol] 1 [symbol] S2PRM protocol computation

$${f}_{S 2 PRM} ( {a}_{1} , {a}_{2} ) = {a}_{1} \times {a}_{2} = {V}_{1}^{〈 1 〉} + {V}_{2}^{〈 1 〉} ,$$

obtaining value results

$${V}_{1}^{〈 1 〉} and {V}_{2}^{〈 1 〉} ,$$

respectively.

Step 2: Execute the following process in a loop for a total of N−2 times: For layer i (1<i≤N−2) of the loop, based on an S2PRM protocol, i+2 participants of i+1 layers execute a total of i+1 rounds of S2PRM protocol (<i> in FIG. 8 indicates layer i), where in the j-th round (1≤j≤i+1) of the S2PRM protocol, participants Pⱼ and Pᵢ₊₂ input their respective private input values

$${V}_{j}^{〈 i 〉} and {a}_{i + 2} to compute {f}_{S 2 PRM} ( {V}_{j}^{〈 i 〉} , {a}_{i + 2} ) = {V}_{j}^{〈 i 〉} \times {a}_{i + 2} = {V}_{j}^{〈 i + 1 〉} + {V}_{( i + 2 ) j}^{〈 i + 1 〉} ,$$

obtaining numerical results

$${V}_{j}^{〈 i + 1 〉} and {V}_{( i + 2 ) j}^{〈 i + 1 〉} ,$$

respectively. Subsequently, participant Pᵢ₊₂ locally computes

$${V}_{i + 2}^{〈 i + 1 〉} = {\sum }_{j = 1}^{i + 1} {V}_{( i + 2 ) j}^{〈 i + 1 〉} .$$

Step 3: All participants Pᵢ (1≤i≤N) obtain respective private values

$${V}_{i}^{〈 N - 1 〉} ∈ {R}^{m} ,$$

thus obtaining

$${U}_{i} = {V}_{i}^{〈 N - 1 〉} .$$

The participants then send Uᵢ to a computation requester, who aggregates the received values to obtain

$$f ( {a}_{1} , {a}_{2} , … , {a}_{N} ) = {\sum }_{i = 1}^{N} {U}_{i} = {a}_{1} \times {a}_{2} \times … \times {a}_{N} .$$

It can be readily verified that

$${\sum }_{i = 1}^{N} {U}_{i} = = ( ( ( {a}_{1} \times {a}_{2} ) \times {a}_{3} ) \times … \times {a}_{N} ) = {a}_{1} \times {a}_{2} \times ... \times {a}_{N} .$$

Based on the foregoing protocol process, the present disclosure provides a secure real-number multiplication method based on scale transformation, applied in scenarios where more than two participants perform secure real-number multiplication. The secure real-number multiplication method based on scale transformation includes the following steps:

(1) An n-th participant receives a secure multi-party real-number multiplication request sent by a computation requester, and determines an n-th private input value based on the secure multi-party real-number multiplication request, where n=1, 2, . . . , N, and N is the number of participants.

$$Set i = 1 . \qquad ( 2 )$$

(3) For layer i of a loop, determine i+1 participants involved in the layer i of the loop, where the i+1 participants include a first participant to an (i+1)-th participant, and i=1, 2, . . . , N−1.

(4) A j-th participant and the (i+1)-th participant that use a j-th private input value and an (i+1)-th private input value as inputs, a j-th private output value and an (i+1)-th private output value by utilizing the secure real-number multiplication method based on scale transformation as described above, where j=1, 2, . . . , i.

(5) Determine whether i equals N−1.

(6) If yes, use the j-th private output value as a final j-th private output value and a sum of all j-th private output values and the (i+1)-th private output value as a final (i+1)-th private output value; the n-th participant sends a final n-th private output value to the computation requester; and the computation requester calculates a sum of N final private output values, to obtain a secure multi-party real-number multiplication result.

(7) If not, use the j-th private output value as a j-th private input value and a sum of all j-th private output values and the (i+1)-th private output value as an (i+1)-th private input value, increment i by 1, and return to the step of “determining i+1 participants involved in the layer i of the loop”.

The present disclosure extends the S2PRM protocol to propose an SNPRM protocol. By transforming values into matrices through scale transformation and invoking

$$\frac{N \times ( N - 1 )}{2}$$

rounds of S2PM protocol for parallel computation, the final result can be obtained, addressing the scalability issues of garbled circuit, secret sharing, and homomorphic encryption technologies. The SNPRM protocol proposed in the present disclosure, due to its random splitting of each value into m distinct positive numbers, ensures that after the S2PM protocol is executed to obtain the matrix result of each participant, the original data of each participant remains secure even if there is partial data leakage (with the number of leaked items not exceeding m). Additionally, this protocol does not rely on third-party cloud platforms, thus mitigating the risk of data leakage due to attacks on third-party cloud platforms associated with the homomorphic encryption technology.

The present disclosure proposes a privacy protection solution for the secure two-party real-number multiplication problem for the first time. The key technical point lies in the introduction of a scale transformation method that converts numerical space into matrix space. Based on a positive integer m jointly negotiated by both parties, the numerical values are split into vectors and then transformed into matrices. This transformation process involves the privacy of original data of the participants and is an important step in ensuring security. The computation is performed using an S2PM protocol implemented based on the secure data disguising technology. The computation process is based on the real number domain, which can ensure minimal loss of computational accuracy in floating-point operations, and the computational complexity only requires O(m²). Compared to ciphertext computation, which has higher complexity, this approach improves computational efficiency by using a space-for-time strategy. The final result is generated through dimensionality reduction transformation, converting the output matrix into numerical values, and by outputting only two numerical results, the security of the original matrix as the output result is protected. The SNPRM protocol proposed in the present disclosure, compared to repeatedly invoking the S2PRM protocol, directly processes the data of all participants in the preprocessing stage and uses the output of each layer directly as the input for the next layer. This eliminates the time spent on repeatedly invoking the preprocessing of the S2PRM protocol, thereby demonstrating strong scalability while improving multi-party computational efficiency through parallelization.

The present disclosure further provides an implementation apparatus for the S2PRM protocol, as shown in FIG. 9. First, a corresponding distributed computing framework needs to be deployed for computation participants involved in the secure real-number multiplication task. The computing framework consists of five modules, specifically including: a task acquisition module, a secure computation module, a rule generation module, a consensus computation module, and a data transmission module. The task acquisition module is responsible for receiving and decoding a privacy-preserving computation request from a computation requester; the secure computation module automatically matches a corresponding secure computation protocol according to the parsed privacy-preserving computation request; the rule generation module implements task decomposition according to an asynchronous instruction set of the secure computation protocol, with different participants execute collaborative computation according to their respective rules; the consensus computation module ensures synchronicity and result consistency of the computation by using a consensus protocol after receiving the assigned rules; the data transmission module collects and transmits the computation results of the participants to the computation requester after the computation is completed.

A specific implementation is as follows: An external client sends a request for a secure two-party real-number multiplication to a network terminal deployed with a distributed computation service through an HTTP or GRPC communication protocol. When a task acquisition module of a node on a network receives the request for a secure two-party real-number multiplication, the task acquisition module parses the request and starts a secure computation service process corresponding to computation participant node 1 and node 2. After the task acquisition module parses the corresponding computation requirement, the task acquisition module transmits a result to the secure computation module, which performs a joint query through an internal interface, and synchronizes the result to the rule generation modules in the two participant nodes after matching a corresponding secure computation protocol. The rule generation module makes different asynchronous parallel execution flows according to different subtasks assumed by the two different participant nodes, and maintains communication with the consensus computation module at each step of execution. The consensus computation module broadcasts and maintains consistency of results of distributed computation nodes on chain and controls stability of the execution flow while the two participant nodes execute each computation instruction. After a final computation protocol is executed, and the two participant nodes obtain computation sub-results of each other, and send, by using the data transmission modules, sub-results obtained after two-party obfuscation splitting to the computation requester to obtain a correct computation result.

Based on the above implementation apparatus, the present disclosure provides a secure real-number multiplication apparatus based on scale transformation, applied in scenarios in which two participants perform secure real-number multiplication, where the secure real-number multiplication apparatus based on scale transformation includes: a computation requester, as well as a task acquisition module, a secure computation module, a rule generation module, a consensus computation module, and a data transmission module corresponding to each participant.

The task acquisition module is configured to receive a secure two-party real-number multiplication request sent by the computation requester.

The secure computation module, the rule generation module, and the consensus computation module are configured to work together to execute the secure real-number multiplication method based on scale transformation as described above, to obtain a private output value of the participant.

The data transmission module is configured to send the private output value to the computation requester.

The computation requester is configured to calculate a sum of private output values of both participants, to obtain a secure two-party real-number multiplication result.

The present disclosure further provides a secure real-number multiplication apparatus based on scale transformation, applied in scenarios in which more than two participants perform secure real-number multiplication, where the secure real-number multiplication apparatus based on scale transformation includes: a computation requester, as well as a task acquisition module, a secure computation module, a rule generation module, a consensus computation module, and a data transmission module corresponding to each participant.

The task acquisition module is configured to receive a secure multi-party real-number multiplication request sent by the computation requester.

The secure computation module, the rule generation module, and the consensus computation module are configured to work together to execute the secure real-number multiplication method based on scale transformation as described above, to obtain a private output value of the participant.

The data transmission module is configured to send the private output value to the computation requester.

The computation requester is configured to calculate a sum of private output values of all participants, to obtain a secure multi-party real-number multiplication result.

The present disclosure has the following advantages:

(1) The present disclosure proposes a S2PRM protocol based on a secure data disguising technology in a semi-honest scenario. Compared to existing homomorphic encryption, secret sharing, and garbled circuit schemes, this protocol reduces the computational complexity to O(m²). Additionally, the number of constant rounds of interaction and the intermediate transmitted data are all real numbers, ensuring that communication costs are kept within a low range, balancing the demands for security, lightweight design, and efficiency.

(2) The present disclosure proposes an S2PRM protocol that transforms real-number multiplication into matrix multiplication through scale transformation after the two participant nodes jointly negotiate m. This allows for parallel computation using the S2PM protocol, resulting in high computational efficiency, fewer communication rounds, and no need to introduce any key encryption operations. Furthermore, due to the characteristics of the S2PRM protocol based on real number operations, it is not limited to integer computation tasks, effectively avoiding precision issues that arise in floating-point processing with garbled circuit and homomorphic encryption technologies.

(3) The present disclosure extends the concept of the S2PRM protocol to propose a SNPRM protocol. For N participant nodes, it requires a total of

$$\frac{N \times ( N - 1 )}{2}$$

rounds or S2PM protocol to obtain the final result, demonstrating scalability and avoiding issues related to constructing large circuit networks when expanding based on the garbled circuit technology, as well as the extensive information exchange when expanding based on the secret sharing technology.

(4) The S2PRM protocol and the SNPRM protocol proposed in the present disclosure provide greater security guarantees. Even in cases where a small amount of intermediate results of the secure matrix multiplication process is leaked, the original data of each participant node remains secure. Additionally, both protocols do not rely on third-party cloud platforms, thereby avoiding the risk of privacy data leakage due to attacks on third-party cloud platforms.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of present disclosure. The description of the foregoing examples is used to help illustrate the method of present disclosure and the core principles thereof. In addition, those of ordinary skill in the art can make various modifications in terms of specific implementations and scope of application in accordance with the teachings of present disclosure. In conclusion, the content of the present specification shall not be construed as a limitation to present disclosure.

1. A secure real-number multiplication method based on scale transformation, applied in scenarios in which two participants perform secure real-number multiplication, wherein the secure real-number multiplication method based on scale transformation comprises:
receiving, by a first participant, a secure two-party real-number multiplication request sent by a computation requester, and determining a first private input value based on the secure two-party real-number multiplication request;
receiving, by a second participant, a secure two-party real-number multiplication request sent by the computation requester, and determining a second private input value based on the secure two-party real-number multiplication request;
negotiating and determining, by the first participant and the second participant, a positive integer m that is greater than or equal to 2;
splitting, by the first participant, the first private input value into m distinct first random positive numbers, forming a first private vector from the m distinct first random positive numbers, and generating a first private input matrix with 1 row and m columns based on the first private vector, wherein a sum of the m distinct first random positive numbers equals the first private input value;
splitting, by the second participant, the second private input value into m distinct second random positive numbers, forming a second private vector from the m distinct second random positive numbers, and generating a second private input matrix with m rows and m columns based on the second private vector, wherein a sum of the m distinct second random positive numbers equals the second private input value;
computing, by the first participant that uses the first private input matrix as input and the second participant that uses the second private input matrix as input, a first private output matrix and a second private output matrix by utilizing a Secure Two-Party Matrix Multiplication (S2PM) protocol based on a secure data disguising technology;
calculating, by the first participant, a sum of elements in the first private output matrix to obtain a first private output value;
calculating, by the second participant, a sum of elements in the second private output matrix to obtain a second private output value; and
sending, by the first participant, the first private output value to the computation requester; sending, by the second participant, the second private output value to the computation requester; and calculating, by the computation requester, a sum of the first private output value and the second private output value to obtain a secure two-party real-number multiplication result,
wherein said computing, by the first participant that uses the first private input matrix as input and the second participant that uses the second private input matrix as input, the first private output matrix and the second private output matrix by utilizing the S2PM protocol based on the secure data disguising technology specifically comprises:
generating, by an auxiliary node, a first random matrix, a second random matrix, a third random matrix, and a fourth random matrix, sending the first random matrix and the third random matrix to the first participant, and sending the second random matrix and the fourth random matrix to the second participant, wherein a product of the first random matrix and the second random matrix equals a sum of the third random matrix and the fourth random matrix;
calculating, by the first participant, a sum of the first private input matrix and the first random matrix to obtain a first sum matrix, and sending the first sum matrix to the second participant;
calculating, by the second participant, a sum of the second private input matrix and the second random matrix to obtain a second sum matrix, and sending the second sum matrix to the first participant;
randomly generating, by the second participant, the second private output matrix, calculating a first product of the first sum matrix and the second private input matrix, calculating a difference between the fourth random matrix and the second private output matrix, calculating a sum of the first product and the calculated difference to obtain a computation matrix, and sending the computation matrix to the first participant; and
calculating, by the first participant, a sum of the computation matrix and the third random matrix, calculating a second product of the first random matrix and the second sum matrix, and calculating a difference between the calculated sum and the second product to obtain the first private output matrix.

2. The secure real-number multiplication method based on scale transformation according to claim 1, wherein said generating the first private input matrix with 1 row and m columns based on the first private vector specifically comprises: using the first private vector as the first private input matrix with 1 row and m columns; and
said generating the second private input matrix with m rows and m columns based on the second private vector specifically comprises: performing a full permutation of each element in the second private vector to obtain a plurality of permutations, with each permutation corresponding to a random sorted vector; and randomly selecting m random sorted vectors to form the second private input matrix with m rows and m columns, wherein the number of permutations is factorial of m.

3. (canceled)

4. A secure real-number multiplication method based on scale transformation, applied in scenarios in which two participants perform secure real-number multiplication, wherein the secure real-number multiplication method based on scale transformation comprises:
receiving, by a first participant, a secure two-party real-number multiplication request sent by a computation requester, and determining a first private input value based on the secure two-party real-number multiplication request;
receiving, by a second participant, a secure two-party real-number multiplication request sent by the computation requester, and determining a second private input value based on the secure two-party real-number multiplication request;
negotiating and determining, by the first participant and the second participant, a positive integer m that is greater than or equal to 2;
splitting, by the first participant, the first private input value into m distinct first random positive numbers, forming a first private vector from the m distinct first random positive numbers, and generating a first private input matrix with 1 row and m columns based on the first private vector, wherein a sum of the m distinct first random positive numbers equals the first private input value;
splitting, by the second participant, the second private input value into m distinct second random positive numbers, forming a second private vector from the m distinct second random positive numbers, and generating a second private input matrix with m rows and m columns based on the second private vector, wherein a sum of the m distinct second random positive numbers equals the second private input value;
splitting, by the second participant, the second private input matrix by columns to obtain m third private input matrices, each with m rows and 1 column;
for each third private input matrix, computing, by the first participant that uses the first private input matrix as input and the second participant that uses the third private input matrix as input, a first private value and a second private value by utilizing a Secure Two-Party Matrix Multiplication (S2PM) protocol based on a secure data disguising technology;
calculating, by the first participant, a sum of m first private values to obtain a first private output value;
calculating, by the second participant, a sum of m second private values to obtain a second private output value; and
sending, by the first participant, the first private output value to the computation requester; sending, by the second participant, the second private output value to the computation requester; and calculating, by the computation requester, a sum of the first private output value and the second private output value to obtain a secure two-party real-number multiplication result,
wherein said computing, by the first participant that uses the first private input matrix as input and the second participant that uses the second private input matrix as input, the first private output matrix and the second private output matrix by utilizing the S2PM protocol based on the secure data disguising technology specifically comprises:
generating, by an auxiliary node, a first random matrix, a second random matrix, a third random matrix, and a fourth random matrix, sending the first random matrix and the third random matrix to the first participant, and sending the second random matrix and the fourth random matrix to the second participant, wherein a product of the first random matrix and the second random matrix equals a sum of the third random matrix and the fourth random matrix;
calculating, by the first participant, a sum of the first private input matrix and the first random matrix to obtain a first sum matrix, and sending the first sum matrix to the second participant;
calculating, by the second participant, a sum of the second private input matrix and the second random matrix to obtain a second sum matrix, and sending the second sum matrix to the first participant;
randomly generating, by the second participant, the second private output matrix, calculating a first product of the first sum matrix and the second private input matrix, calculating a difference between the fourth random matrix and the second private output matrix, calculating a sum of the first product and the calculated difference to obtain a computation matrix, and sending the computation matrix to the first participant; and
calculating, by the first participant, a sum of the computation matrix and the third random matrix, calculating a second product of the first random matrix and the second sum matrix, and calculating a difference between the calculated sum and the second product to obtain the first private output matrix.

5. A secure real-number multiplication method based on scale transformation, applied in scenarios in which more than two participants perform secure real-number multiplications, wherein the secure real-number multiplication method based on scale transformation comprises:
receiving, by an n-th participant, a secure multi-party real-number multiplication request sent by a computation requester, and determining an n-th private input value based on the secure multi-party real-number multiplication request, wherein n=1, 2, . . . , N, and N is the number of participants;
$$setting i = 1 ;$$
for layer i of a loop, determining i+1 participants involved in the layer i of the loop, wherein the i+1 participants comprise a first participant to an (i+1)-th participant, and i=1, 2, . . . , N−1;
computing, by a j-th participant and the (i+1)-th participant that use a j-th private input value and an (i+1)-th private input value as inputs, a j-th private output value and an (i+1)-th private output value by utilizing the secure real-number multiplication method based on scale transformation as described in claim 1, wherein j=1, 2, . . . , i;
determining whether i equals N−1;
if yes, using the j-th private output value as a final j-th private output value and a sum of all j-th private output values and the (i+1)-th private output value as a final (i+1)-th private output value; sending, by the n-th participant, a final n-th private output value to the computation requester; and calculating, by the computation requester, a sum of N final private output values, to obtain a secure multi-party real-number multiplication result; and
if not, using the j-th private output value as a j-th private input value and a sum of all j-th private output values and the (i+1)-th private output value as an (i+1)-th private input value, incrementing i by 1, and returning to the step of “determining i+1 participants involved in the layer i of the loop”.

6. A secure real-number multiplication method based on scale transformation, applied in scenarios in which more than two participants perform secure real-number multiplications, wherein the secure real-number multiplication method based on scale transformation comprises:
receiving, by an n-th participant, a secure multi-party real-number multiplication request sent by a computation requester, and determining an n-th private input value based on the secure multi-party real-number multiplication request, wherein n=1, 2, . . . , N, and N is the number of participants;
negotiating and determining, by the N participants, a positive integer m that is greater than or equal to 2;
splitting, by the n-th participant, the n-th private input value into m distinct n-th random positive numbers, forming an n-th private vector from the m distinct n-th random positive numbers, and generating an n-th private input matrix based on the n-th private vector, wherein a sum of the m distinct n-th random positive numbers equals the n-th private input value;
with N private input matrices as inputs, computing, by the N participants, N private output matrices by utilizing a Secure Two-Party Matrix Multiplication (S2PM) protocol based on a secure data disguising technology, wherein the private output matrix of the n-th participant is an n-th private output matrix;
calculating, by the n-th participant, a sum of elements in the n-th private output matrix to obtain an n-th private output value; and
sending, by the n-th participant, the n-th private output value to the computation requester; and calculating, by the computation requester, a sum of N private output values, to obtain a secure multi-party real-number multiplication result,
wherein said with the N private input matrices as inputs, computing, by the N participants, the N private output matrices by utilizing the S2PM protocol based on the secure data disguising technology specifically comprises:
$$setting i = 1 ;$$
for layer i of a loop, determining i+1 participants involved in the layer i of the loop, wherein the i+1 participants comprise a first participant to an (i+1)-th participant, and i=1, 2, . . . , N−1;
computing, by a j-th participant and the (i+1)-th participant that use a j-th private input matrix and an (i+1)-th private input matrix as inputs, a j-th intermediate matrix and an (i+1)-th intermediate matrix by utilizing the S2PM protocol based on the secure data disguising technology, wherein j=1, 2, . . . , i;
determining whether i equals N−1;
if yes, using the j-th intermediate matrix as a j-th private output matrix and a sum of all j-th intermediate matrices and the (i+1)-th intermediate matrix as an (i+1)-th private output matrix; and
if not, using the j-th intermediate matrix as a j-th private input matrix and a sum of all j-th intermediate matrices and the (i+1)-th intermediate matrix as an (i+1)-th private input matrix, incrementing i by 1, and returning to the step of “determining i+1 participants involved in the layer i of the loop”.

7. The secure real-number multiplication method based on scale transformation according to claim 6, wherein said generating the n-th private input matrix based on the n-th private vector specifically comprises:
when n equals 1, using the n-th private vector as the n-th private input matrix; and
when n is not equal to 1, performing a full permutation of each element in the n-th private vector to obtain a plurality of permutations, with each permutation corresponding to a random sorted vector; and randomly selecting m random sorted vectors to form the n-th private input matrix, wherein the number of permutations is factorial of m.

8. (canceled)

9. A secure real-number multiplication apparatus based on scale transformation, applied in scenarios in which two participants perform secure real-number multiplication, wherein the secure real-number multiplication apparatus based on scale transformation comprises: a computation requester, as well as a task acquisition module, a secure computation module, a rule generation module, a consensus computation module, and a data transmission module corresponding to each participant;
the task acquisition module is configured to receive a secure two-party real-number multiplication request sent by the computation requester;
the secure computation module, the rule generation module, and the consensus computation module are configured to work together to execute the secure real-number multiplication method based on scale transformation as described in claim 1, to obtain a private output value of the participant;
the data transmission module is configured to send the private output value to the computation requester; and
the computation requester is configured to calculate a sum of private output values of both participants, to obtain a secure two-party real-number multiplication result.

10. A secure real-number multiplication apparatus based on scale transformation, applied in scenarios in which more than two participants perform secure real-number multiplication, wherein the secure real-number multiplication apparatus based on scale transformation comprises: a computation requester, as well as a task acquisition module, a secure computation module, a rule generation module, a consensus computation module, and a data transmission module corresponding to each participant;
the task acquisition module is configured to receive a secure multi-party real-number multiplication request sent by the computation requester;
the secure computation module, the rule generation module, and the consensus computation module are configured to work together to execute the secure real-number multiplication method based on scale transformation as described in claim 5, to obtain a private output value of the participant;
the data transmission module is configured to send the private output value to the computation requester; and
the computation requester is configured to calculate a sum of private output values of all participants, to obtain a secure multi-party real-number multiplication result.

11. A secure real-number multiplication method based on scale transformation, applied in scenarios in which more than two participants perform secure real-number multiplications, wherein the secure real-number multiplication method based on scale transformation comprises:
receiving, by an n-th participant, a secure multi-party real-number multiplication request sent by a computation requester, and determining an n-th private input value based on the secure multi-party real-number multiplication request, wherein n=1, 2, . . . , N, and N is the number of participants;
$$setting i = 1 ;$$
for layer i of a loop, determining i+1 participants involved in the layer i of the loop, wherein the i+1 participants comprise a first participant to an (i+1)-th participant, and i=1, 2, . . . , N−1;
computing, by a j-th participant and the (i+1)-th participant that use a j-th private input value and an (i+1)-th private input value as inputs, a j-th private output value and an (i+1)-th private output value by utilizing the secure real-number multiplication method based on scale transformation as described in claim 4, wherein j=1, 2, . . . , i;
determining whether i equals N−1;
if yes, using the j-th private output value as a final j-th private output value and a sum of all j-th private output values and the (i+1)-th private output value as a final (i+1)-th private output value; sending, by the n-th participant, a final n-th private output value to the computation requester; and calculating, by the computation requester, a sum of N final private output values, to obtain a secure multi-party real-number multiplication result; and
if not, using the j-th private output value as a j-th private input value and a sum of all j-th private output values and the (i+1)-th private output value as an (i+1)-th private input value, incrementing i by 1, and returning to the step of “determining i+1 participants involved in the layer i of the loop”.

12. A secure real-number multiplication apparatus based on scale transformation, applied in scenarios in which two participants perform secure real-number multiplication, wherein the secure real-number multiplication apparatus based on scale transformation comprises: a computation requester, as well as a task acquisition module, a secure computation module, a rule generation module, a consensus computation module, and a data transmission module corresponding to each participant;
the task acquisition module is configured to receive a secure two-party real-number multiplication request sent by the computation requester;
the secure computation module, the rule generation module, and the consensus computation module are configured to work together to execute the secure real-number multiplication method based on scale transformation as described in claim 4, to obtain a private output value of the participant;
the data transmission module is configured to send the private output value to the computation requester; and
the computation requester is configured to calculate a sum of private output values of both participants, to obtain a secure two-party real-number multiplication result.

13. A secure real-number multiplication apparatus based on scale transformation, applied in scenarios in which more than two participants perform secure real-number multiplication, wherein the secure real-number multiplication apparatus based on scale transformation comprises: a computation requester, as well as a task acquisition module, a secure computation module, a rule generation module, a consensus computation module, and a data transmission module corresponding to each participant;
the task acquisition module is configured to receive a secure multi-party real-number multiplication request sent by the computation requester;
the secure computation module, the rule generation module, and the consensus computation module are configured to work together to execute the secure real-number multiplication method based on scale transformation as described in claim 6, to obtain a private output value of the participant;
the data transmission module is configured to send the private output value to the computation requester; and
the computation requester is configured to calculate a sum of private output values of all participants, to obtain a secure multi-party real-number multiplication result.
